(19) United States
(12) Patent Application Publication
(10) Pub. No.: US 2009/0228349 A1
(43) Pub. Date: Sep. 10, 2009

(54) MOORING SYSTEM

(76) Inventors: Roger Wayne Richard Dyhrberg, Henderson (AU); Terry Cullen, Austinmer (AU)

Correspondence Address: OSTROLENK FABER GERB & SOFFEN, 1180 AVENUE OF THE AMERICAS, NEW YORK, NY, 100368403, US

(21) Appl. No.: 11/568,064

(22) PCT Filed: Apr. 19, 2005
(86) PCT No.: PCT/AU05/00554

§ 371 Date: Jan. 6, 2009

(30) Foreign Application Priority Data
Apr. 19, 2004 (AU) 2004902047

(51) Int. Cl. G06F 19/00; G06F 17/30

(52) U.S. Cl. 705/13; 707/200; 707/E17.01

(57) ABSTRACT

A mooring system (10) is disclosed which comprises a database (24) arranged to store a plurality of mooring records, each mooring record including information indicative of a mooring, booking information indicative of whether the mooring is booked, and booking data indicative of the identity of the user in respect of which the mooring is booked and of the date and/or time period for which the mooring is booked. The system (10) also includes communications means (22) arranged to facilitate communications between the system (10) and a remotely located user device (12, 14, 16, 187, 19) such that booking information is receivable by the remotely located user device from the mooring system (10) for viewing by a user. A corresponding method is also described.

### FIELD OF THE INVENTION

The present invention relates to a mooring system.

### BACKGROUND OF THE INVENTION

It is known to provide moorings of various types for use by vessels to maintain the vessel at a relatively fixed position on a body of water without the need to use the vessel's anchor which may cause damage to the environment. Currently available moorings are generally either government operated and controlled and useable by the public, or privately owned and useable only by those authorised by the owner.

However, in some areas the number of moorings available for use by the public is insufficient to meet the demand.

In the present specification the term “mooring” will be understood to mean a place or apparatus usable to moor a boat and includes sea-bed anchors, pens, docks, and so on.

### SUMMARY OF THE INVENTION

In accordance with a first aspect of the present invention, there is provided a mooring system comprising:
a database arranged to store a plurality of mooring records, each mooring record including:
   information indicative of a mooring;
   booking information indicative of whether the mooring is booked; and
   if the mooring is booked, booking data indicative of the identity of the user in respect of which the mooring is booked and of the date and/or time period for which the mooring is booked; and
communications means arranged to facilitate communications between the system and a remotely located user device such that booking information is receivable by the remotely located user device from the mooring system for viewing by a user;
wherein the system is arranged so as to facilitate searching through the mooring records based on user defined criteria.

In one arrangement, the system is arranged such that during use booking information associated with a mooring desired to be booked by a user is receivable from a remotely located user device, and the mooring record associated with the desired mooring is updated so as to indicate that the mooring is booked and so as to include the identity of the user and the date and/or time period for which the mooring is booked.

In one arrangement, each mooring record includes maintenance information indicative of the condition of a mooring at a previous service. The maintenance information may also include information indicative of the expected condition of the mooring at a subsequent service, the suggested next service date, and/or whether each component of the mooring is expected to require replacing at a subsequent service. The maintenance information may include information indicative of measurements of components of a mooring. The system may also be arranged to facilitate entry of measurement data into each mooring record, which data is used to update current measurement information in the mooring record.

In one arrangement, the system is arranged so as to facilitate ordering of mooring components. The system may also be arranged to facilitate ordering of marine related equipment, materials, accessories or services.

In one arrangement, the system is arranged so as to facilitate access to the system by remote user devices associated with members of the public, owners of moorings, controlling authorities, operators of marinas, yacht clubs, harbour masters, insurance companies and/or mooring contractors. The system may be arranged to modify communications to the devices depending on the type of user.

The system may also be arranged to store information indicative of moorings and/or vessels available for sale and to make information indicative of the moorings and/or vessels available for sale viewable using a remotely located user device.

The system may be arranged such that the system is communicable with user devices in the form of computing devices which may be personal computing devices, portable computing devices, personal digital assistants (PDA), mobile telephones, and any other communications enabled computing device.

The system may be arranged to facilitate communications with remote computing devices through the Internet, by SMS messaging, or using any other suitable communications mechanism.

In one arrangement, the system includes a system computing device arranged to serve web pages to remotely located user devices.

In accordance with a second aspect of the present invention, there is provided a method of managing moorings, said method comprising the steps of:
providing a database;
storing in the database a plurality of mooring records, each mooring record including information indicative of the mooring and booking information indicative of whether the mooring is booked, and, if the mooring is booked, booking data indicative of the identity of the user in respect of which the mooring is booked and of the date and/or time period for which the mooring is booked;
facilitating communications between the system and a remotely located user device such that booking information is receivable by the remotely located user device from the database for viewing by a user; and
facilitating searching through the mooring records based on user defined criteria.

The method may further comprise the steps of:
facilitating reception of booking data from a remotely located user device; and
updating a mooring record associated with a mooring so as to indicate the identity of the user and the date and/or time period for which the mooring is booked when booking data associated with the mooring is received from a remotely located user device.

In accordance with a third aspect of the present invention, there is provided a computer program arranged, when loaded into a computer, to instruct the computer to operate in accordance with a mooring system as described in the first aspect of the present invention.

In accordance with a fourth aspect of the present invention, there is provided a computer useable medium having a computer readable program code embodied therein for causing a computer to operate in accordance with a mooring system as desired in the first aspect of the present invention.

### DESCRIPTION OF THE DRAWINGS

The present invention will now be described, by way of example only, with reference to the accompanying drawings, in which:

FIG. 1 is a block diagram of a mooring system in accordance with an embodiment of the present invention with the mooring system shown in relation to a plurality of computing devices; and

FIGS. 2 to 20 are representations of screens of the mooring system shown in FIG. 1.

### DESCRIPTION OF AN EMBODIMENT OF THE PRESENT INVENTION

In the following description of an embodiment of the invention, it will be understood that the invention may be implemented as hardware and/or software using an appropriate platform such as a computing system.

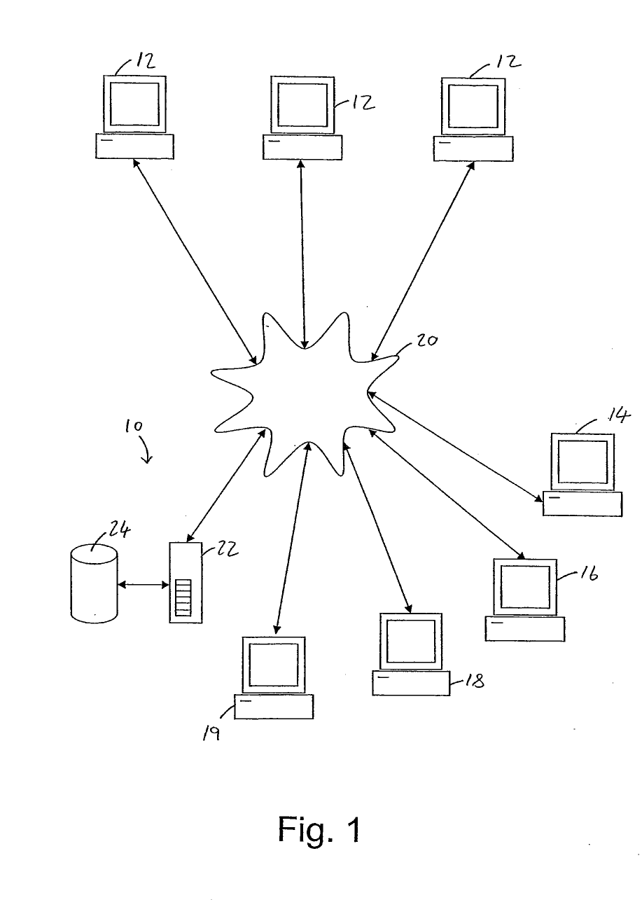

Referring to the drawings, in FIG. 1 there is shown a mooring system 10 during use in communication with public terminals 12 associated with persons desiring to access the mooring system 10 for the purpose of booking and/or purchasing a mooring, an owner terminal 14 associated with an owner of a mooring, an authority terminal 16 associated with a controlling authority, an insurer terminal 18 associated with an insurer having an insurance risk in at least one of the moorings, and a mooring contractor terminal 19 associated with mooring contractors having an interest in installing and maintaining moorings.

In this example, the public terminals 12, the owner terminal 14, the authority terminal 16, the insurer terminal 18 and the mooring contractor terminal 19 communicate with the mooring system 10 through the Internet 20. However, it will be understood that any communications arrangement is envisaged, the important aspect being that the terminals 12, 14, 16, 18, 19 are able to communicate with the mooring system 10 from a remote location. For example, the mooring system 10 and the terminals 12, 14, 16, 18, 19 may be arranged so as to communicate with each other using SMS messaging.

It will also be understood that although only one owner terminal 14, one authority terminal 16, one insurer terminal 18 and one mooring contractor terminal 19 are illustrated in FIG. 1, any number of these terminals may be present.

The mooring system 10 includes a system terminal 22 arranged to communicate with the terminals 12, 14, 16, 18, 19 and to serve web pages to the terminals 12, 14, 16, 18, 19 in response to requests from the terminals 12, 14, 16, 18, 19.

The mooring system 10 also includes a database 24 arranged to store log-in details for users authorised to access the system 10, and a plurality of mooring records. Each mooring record includes information indicative of the owner of the mooring;
the controlling authority responsible for the mooring;
the insurance company having an insurance risk in the mooring;
the location of the mooring; and
booking information indicative of whether the mooring is booked, of the identity of the or each user for which the mooring is booked, and of the date and/or time period for which the mooring is booked.

Each mooring record also includes maintenance information useable to coordinate and manage maintenance operations on moorings recorded with the system 10.

The arrangement of the system is such that the mooring records are accessible through public terminals 12 and users of the public terminals 12 are able to search and book one or more desired moorings on-line, such that the mooring records are accessible through owner terminals 14 so that an owner may view his/her moorings, such that the mooring records are accessible through authority terminals 16 so that a controlling authority may review moorings controlled by the authority, such that the mooring records are accessible by insurer terminals 18 so that an insurance company may review moorings for which the insurance company has risk exposure, and such that the mooring records are accessible by mooring contractor terminals 19 so that a mooring contractor may review details of moorings, add new moorings, and manage maintenance and installation of moorings for which the mooring contractor is responsible.

In the present example, the mooring system 10 is arranged so that the interface between the terminals 12, 14, 16, 18, 19 and the system 10 is web based and, as such, web pages are served to the terminals during use to facilitate transfer of information to the terminals, reception of information from the terminals and searching of the mooring records stored in the database 24.

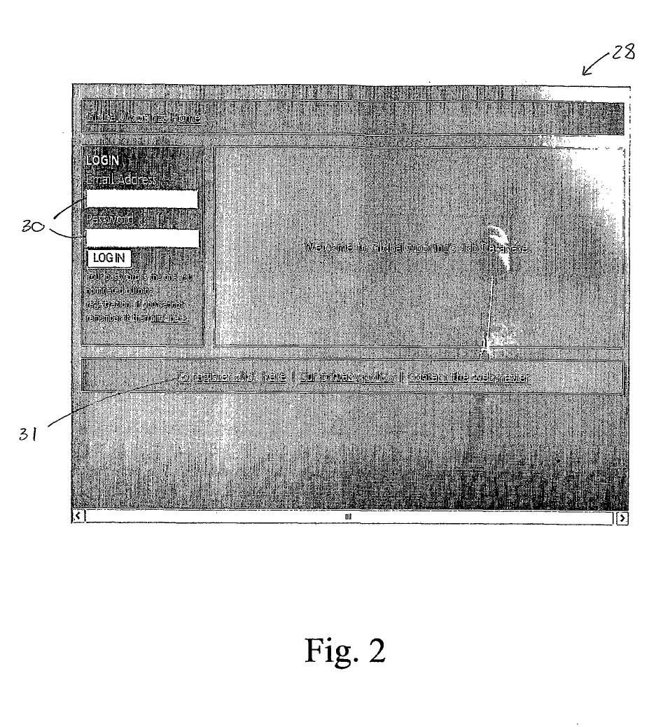

Referring to FIGS. 2 to 20, an example of a web based implementation of the mooring system 10 shown in FIG. 1 will now be described.

The mooring system 10 includes two sections. A first section is a mooring maintenance section useable by mooring contractors to view, modify and manage mooring installation and maintenance of moorings for which the mooring contractors are responsible, and by controlling authorities and insurance companies to view mooring maintenance information relating to moorings for which the controlling authority or insurance company are responsible. A second section is a mooring booking section useable by the public to search for and book moorings, and by owners of the moorings to make moorings available for booking by members of the public.

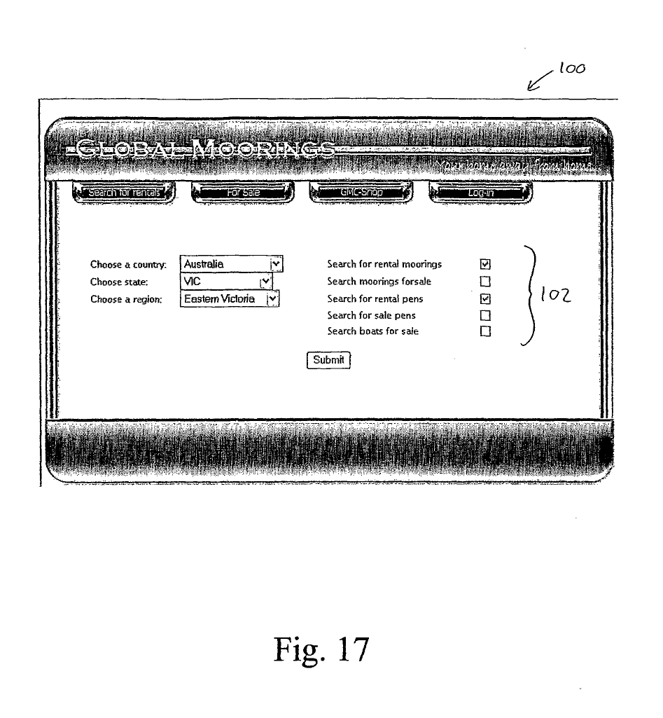

FIGS. 2 to 16 of the drawings show screens of an example mooring maintenance section of the mooring system 10 and FIGS. 17 to 20 show screens of an example mooring booking section of the mooring system 10.

In FIG. 2, there is shown a log-in screen 28 which is served to a terminal 12, 14, 16, 18, 19 when the mooring system 10 is first accessed by the terminal and a user has selected a maintenance section of the mooring system 10. Using the log-in screen 28, a user already registered with the system is able to enter log-in and password details into log-in boxes 30 in order to gain access to the system terminal 22 and the database 24. A new user is able to register with the system by activating a register link 31.

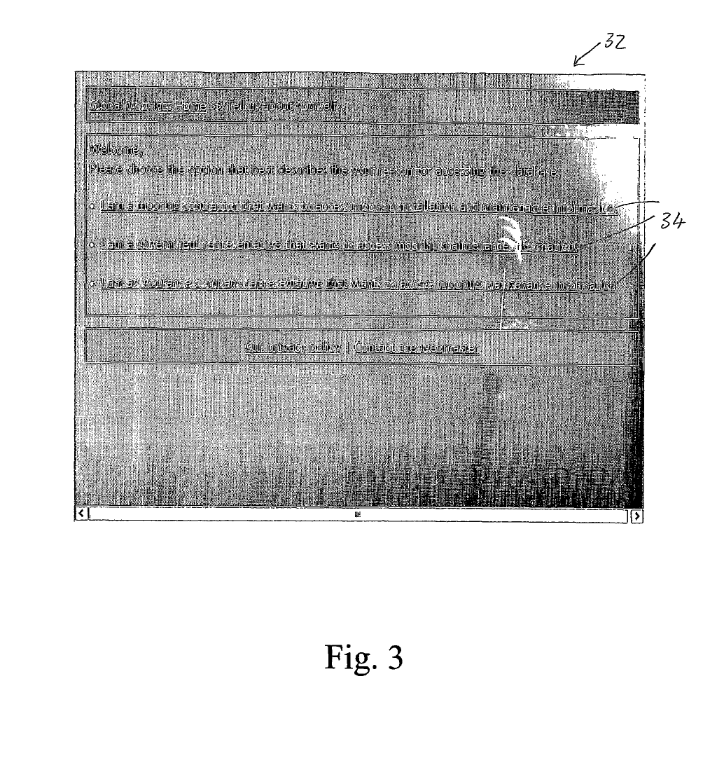

Following activation of the register link 31 or successful log-in of an existing registered user desiring to access the maintenance section, the system terminal 22 serves a user selection screen 32 as shown in FIG. 3 to the relevant authority terminal 16, insurer terminal 18 or contractor terminal 19. The user selection screen 32 is used to indicate to the mooring system 10 whether the user is a representative of a mooring contractor, a representative of a controlling authority, or a representative of an insurance company. Selection of the user type is carried out by selecting an appropriate user type link 34 displayed on the user selection screen 32.

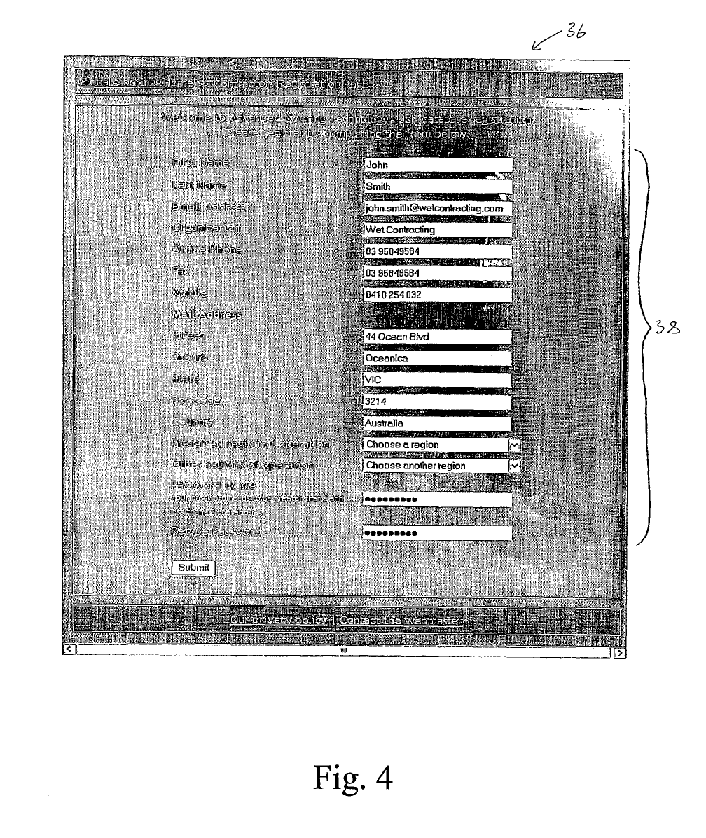

If the user selects a user type link 34 indicating that the user is a mooring contractor and the contractor is not already registered with the system 10, a contractor details screen 36 as shown in FIG. 4 is served to the contractor terminal 19. The contractor details screen 36 is used to gather name, address and contact details of the contractor together with details of the regions serviced by the contractor. For this purpose, contractor details boxes 38 are provided on the contractor details screen 36. The contractor details boxes 38 also facilitate entry of a password for use during subsequent log-in by the contractor.

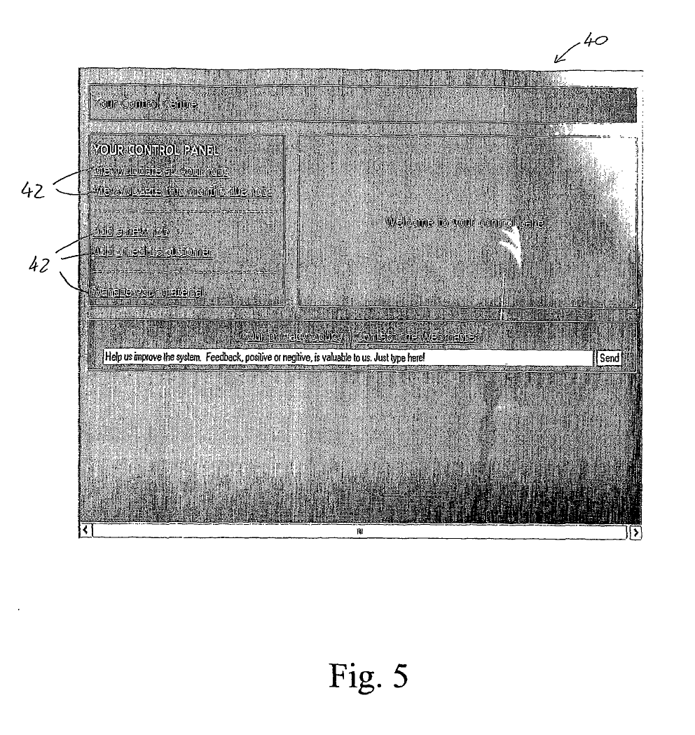

As shown in FIG. 5, following successful log-in or completion of initial registration with the mooring system 10, the system terminal 22 serves a home page screen to the relevant terminal 19, in this example a contractor home page screen 40. However, it will be understood that if the user is a representative of a controlling authority or an insurance company the home page screen 40 would be modified to suit the controlling authority or insurance company.

The contractor home page screen 40 includes contractors links 42 useable to view or update jobs to be carried out on moorings associated with the mooring contractor; to view or update jobs due to be carried out in the current month; to add a new job to be carried out on a mooring; to add or edit a customer of the mooring contractor, that is an owner of a mooring or a controlling authority responsible for a mooring; or to manage material required by the mooring contractor to carry out maintenance on the moorings associated with the mooring contractor.

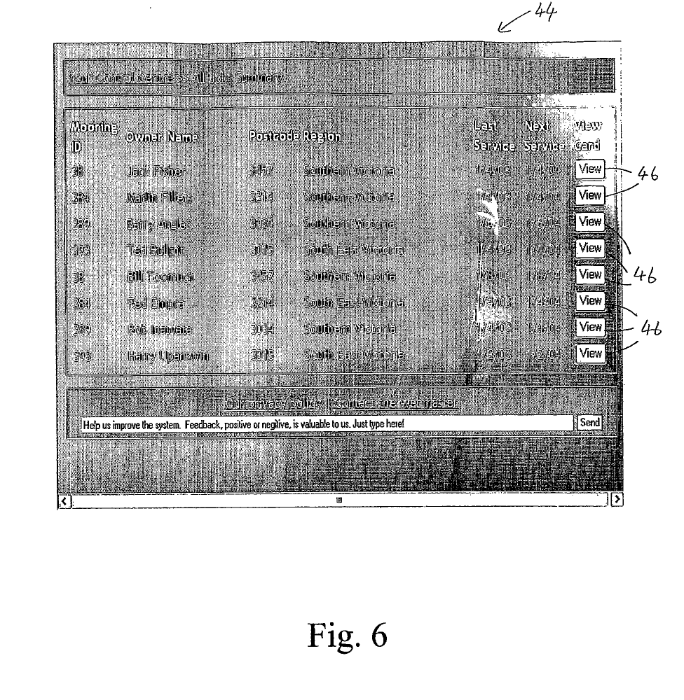

By selecting an appropriate contractor link 42, the user is able to display a jobs screen 44 as shown in FIG. 6. The jobs screen 44 displays a summary of all moorings for which the contractor is responsible, and basic details of the moorings including a mooring ID number, the name of the owner of the mooring, an indication of the region in which the mooring is located, and details of the last and next service dates.

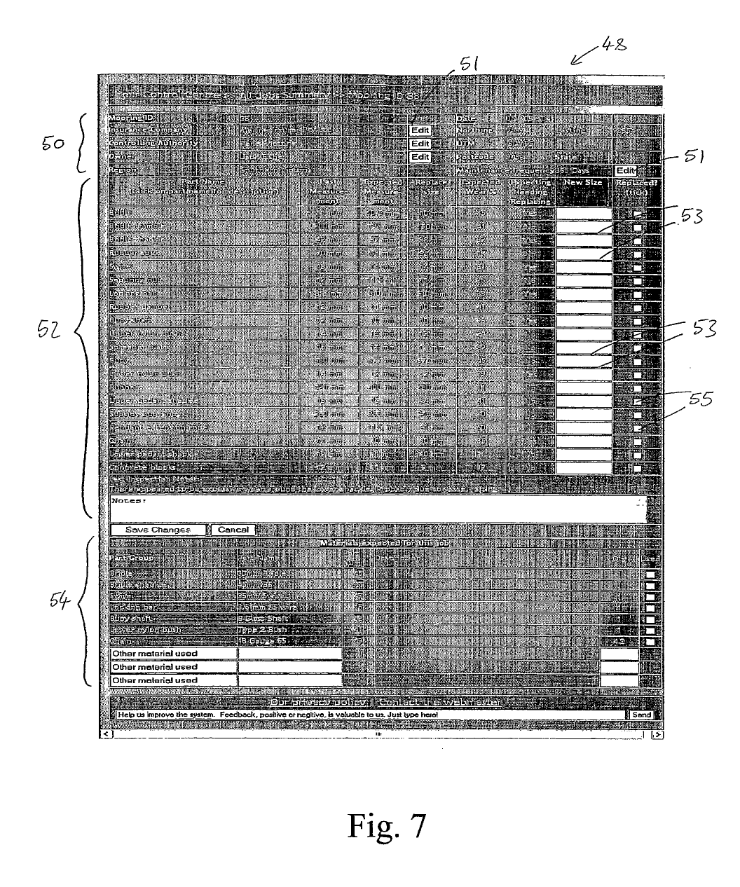

The jobs screen 44 also includes a view job button 46 for each displayed job, activation of a view job button 46 causing a job details screen 48 as shown in FIG. 7 to be displayed.

The job details screen 48 serves as a service record for a mooring to indicate the results of a previous service, and as an aid to subsequent services by predicting which components of the mooring will need to be replaced at a subsequent service.

The job details screen 48 includes basic mooring details 50 which identifies the mooring ID number, the insurance company responsible for the mooring, the controlling authority responsible for the mooring, the owner of the mooring, the location of the mooring, and the frequency at which mooring servicing should occur. As indicated by edit buttons 51, insurance company, controlling authority, and maintenance frequency fields are modifiable by selecting the appropriate edit button 51.

The job details screen 48 also includes mooring maintenance details 52 having information indicative of measurements of components of the mooring taken at a previous service, measurements expected at a subsequent service, a replacement measurement indicative of the threshold measurement below which replacement of a component is necessary, the expected wear on each component, and whether each component is expected to require replacing. Current measurement boxes 53 are also provided for entering measurements taken at a service and replaced check boxes 55 are provided for indicating whether a component has been replaced during the service.

The job details screen 48 also includes expected materials details 54 which is derived from the mooring maintenance details 52 and which lists the components which are likely to require replacing and which should therefore be taken to the next service.

In this example, as part of a service operation, a representative of a mooring contractor prints the job details screen 48 and takes the printed job details screen to a service. During the service, the representative writes current measurements in the current measurement boxes 53 and marks the appropriate check boxes 55 to indicate the components that have been replaced. The data written on the printed job details screen can then be used to complete the current measurement boxes 53 and the check boxes 55 on the job details screen 48 so as to thereby update the mooring maintenance details 52 after completion of the service.

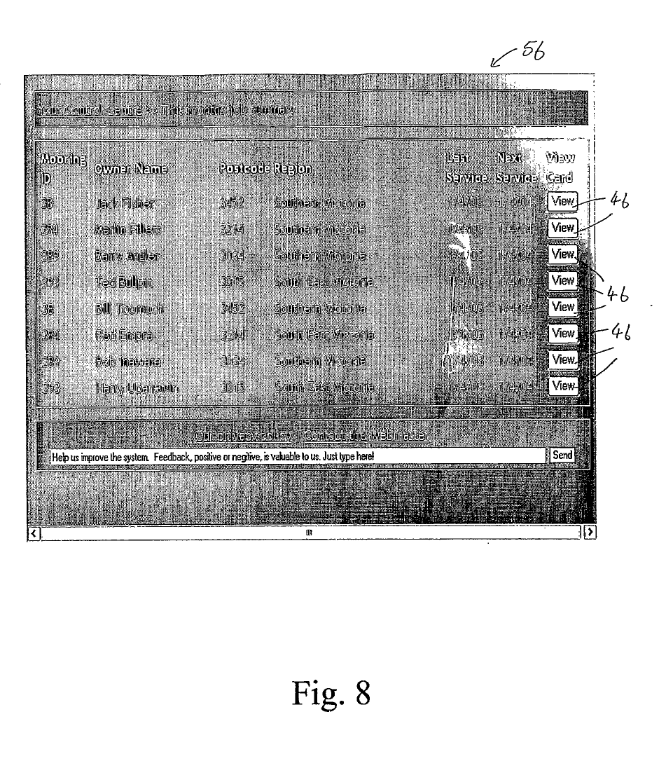

By selecting an appropriate contractor link 42 on the contractor home page screen 40, a monthly job screen 56 as shown in FIG. 8 may be displayed. The monthly job screen 56 displays details of all service jobs which are scheduled to be carried out for the current month. As with the job details screen 48, the monthly job screen 56 includes details of the mooring ID number, the name of the owner of the mooring, an indication of the location of the mooring, and details of the last and next service dates. Each mooring also has an associated view jobs button 46 which, when activated, causes the job details screen 48 to be displayed.

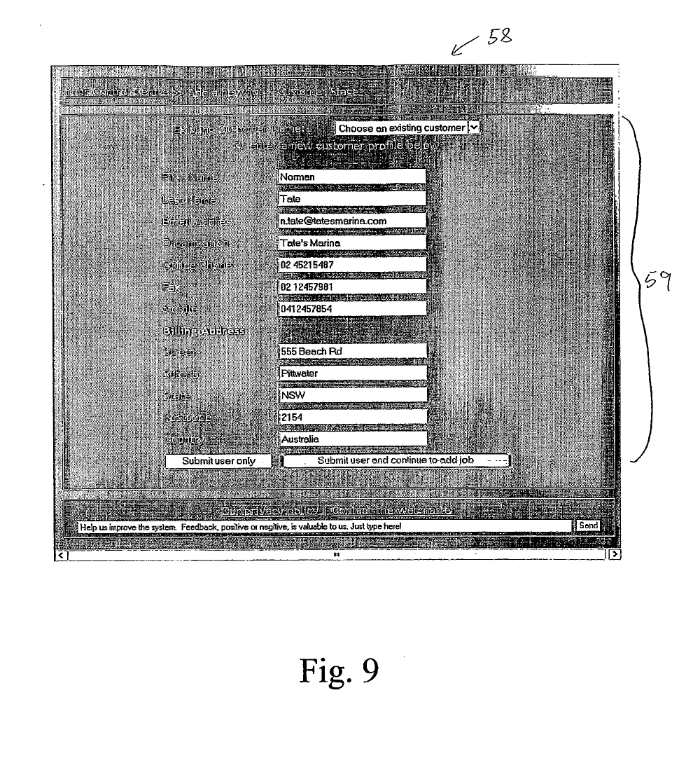

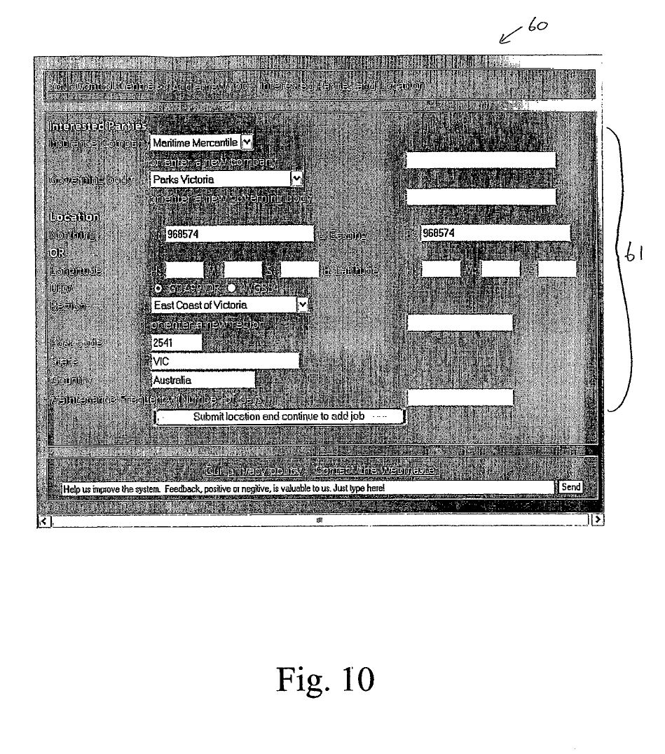

By selecting an appropriate contractor link 42 on the contractor home page screen 40, an owner details screen 58 as shown in FIG. 9 may be displayed. Using owner details boxes 59 on the owner details screen 58, a contractor is able to commence creation of a new service job by either selecting an existing customer, that is a mooring owner already recorded on the mooring system 10, or by entering details of a new customer. Following selection of an existing customer or entry of details of a new customer, a mooring location screen 60 as shown in FIG. 10 is displayed. Using mooring location details boxes 61 on the mooring location screen 60, the contractor is able to enter location details for the new mooring and details of the responsible insurance company and controlling authority associated with the new mooring. The mooring location system 10 may also include a mechanism whereby a contractor is able to select the location of a mooring using an interactive map.

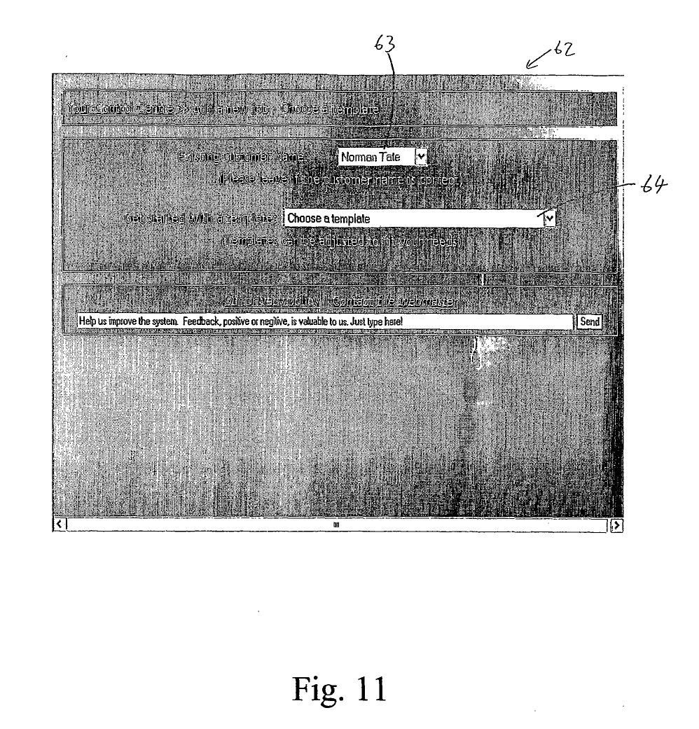

Following entry of the mooring location details, a template selection screen 62 as shown in FIG. 11 is displayed. Using a customer name box 63 and a template selection box 64 on the template selection screen 62, the contractor is able to select a predefined mooring template which corresponds to the type of mooring to be added.

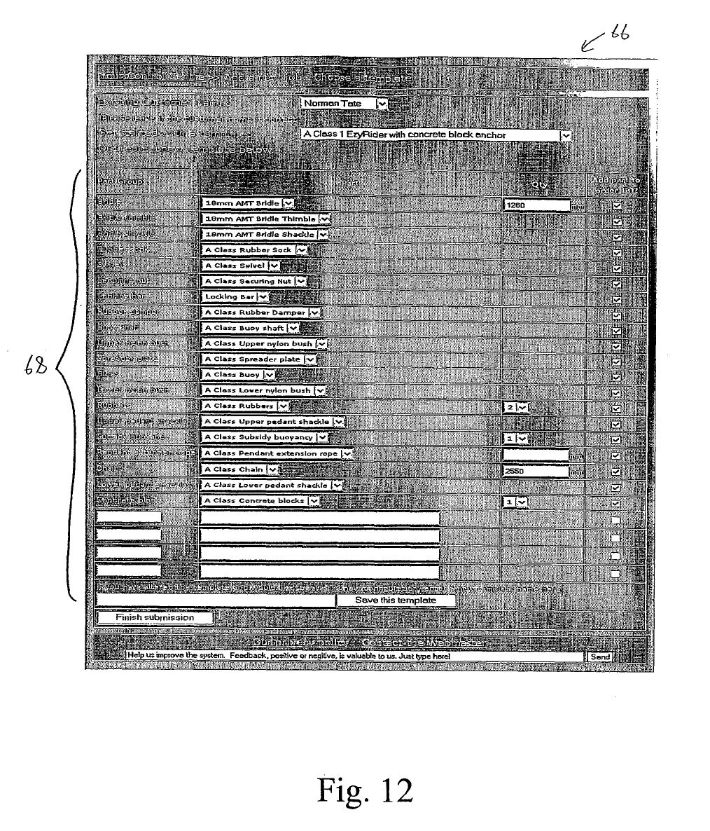

Following selection of a mooring template, a mooring component screen 66 as shown in FIG. 12 is displayed. For some types of moorings, using mooring components boxes 68 on the mooring component screen 66, the contractor is able to modify details of the components for the mooring so as to correspond with the actual components of the mooring to be added. The remainder of the moorings are non-modifiable.

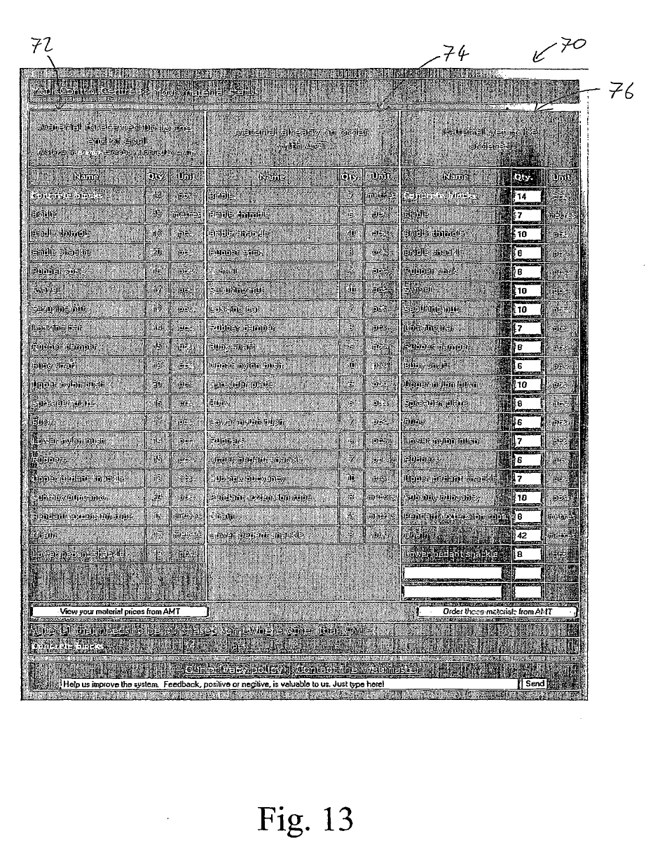

It will be understood that the mooring system 10 may be used by contractors to order required mooring components necessary for servicing operations and, for this purpose, by activating an appropriate contractor link 42 on the contractor home page screen 40, a component order screen 70 as shown in FIG. 13 is displayed. The component order screen 70 includes details of forecasted components 72 derived from the expected materials details 54 of all moorings for which the contractor is responsible, details of ordered components 74 which have already been ordered by the contractor, and updated order boxes 76 which are useable by the contractor to update the quantity of ordered components.

If the user is a representative of a controlling authority or a representative of an insurance company, the relevant user type link 34 on the user selection screen 32 relating to the controlling authority or insurance company is selected and, following successive log-in or successful registration of the controlling authority or insurance company, a controlling authority home page or insurance company home page is displayed as appropriate. It will be understood that similar information is displayed and similar options are available to the controlling authorities and the insurance companies, except the controlling authorities and the insurance companies are unable to modify any of the displayed details and less information is displayed.

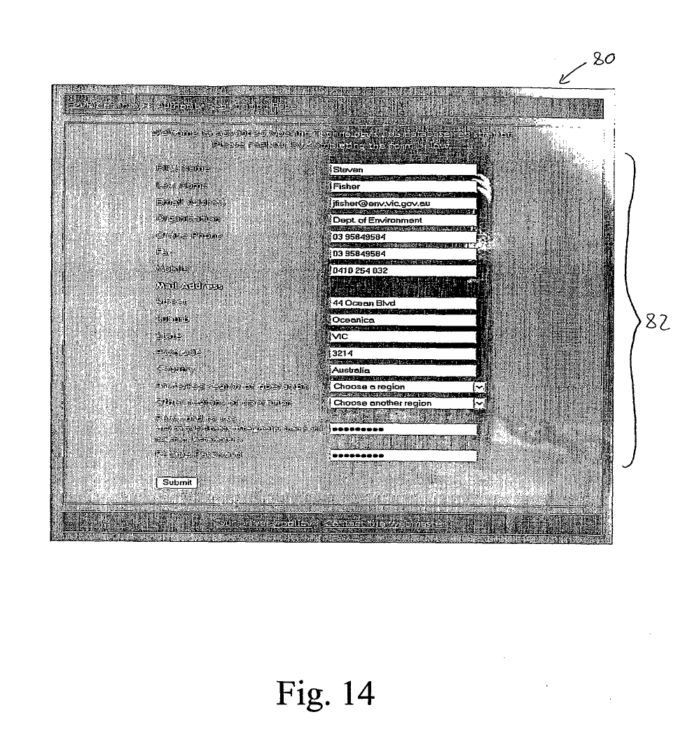

As with the mooring contractors, new controlling authorities not already registered with the mooring system 10 must enter name, address and region of operation details together with a password prior to gaining access to the mooring system 10. This is carried out by entering details into authority details boxes 82 on an authority details screen 80 as shown in FIG. 14.

A similar process and insurer details screen (not shown) is used to register new insurance companies with the mooring system 10.

As with the mooring contractors registered with the mooring system 10, the insurance companies are required to enter name, address and password details in order to register with the system.

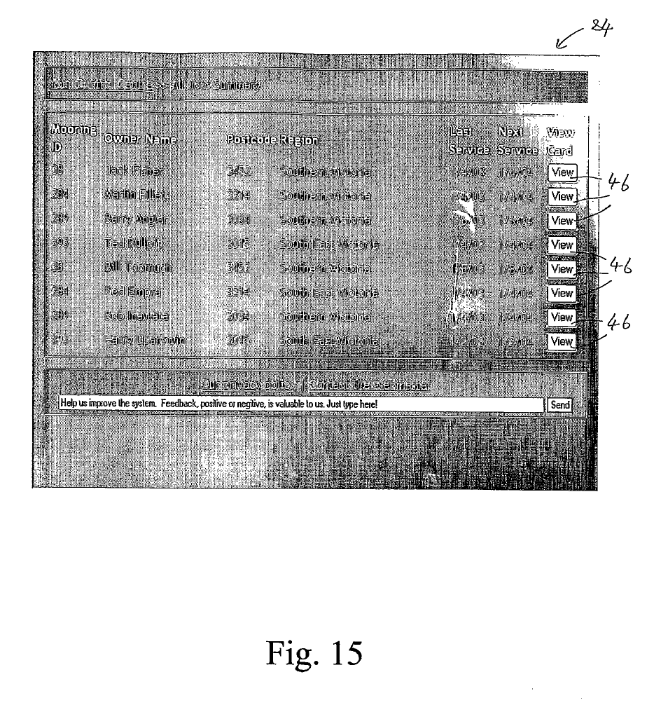

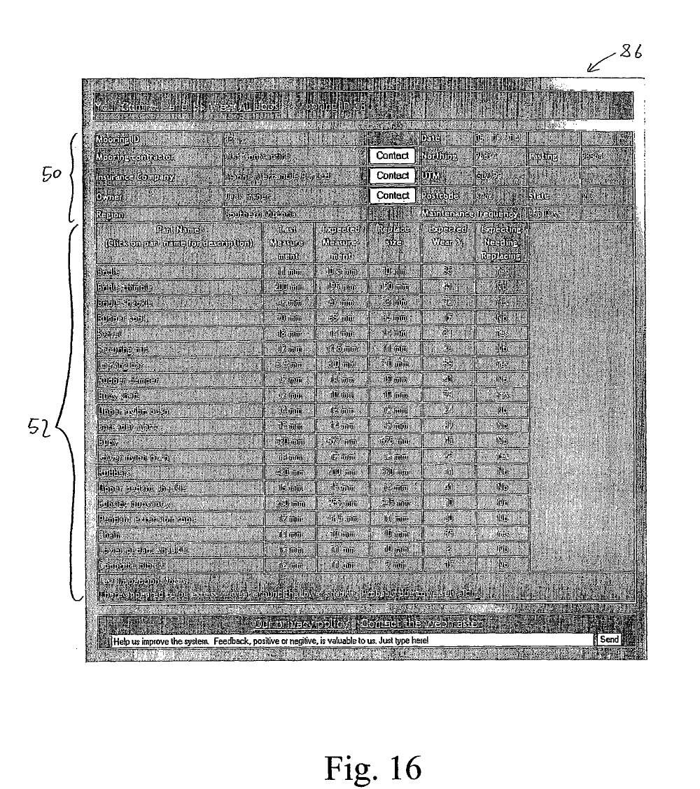

As with the mooring contractors registered with the system 10, each of the controlling authorities and the insurance companies are also able to view all jobs for which the controlling authority or insurance company is responsible and a jobs screen 84 as shown in FIG. 15 is provided for this purpose. As with the jobs screen 44 provided for the mooring contractors, each mooring listed on the jobs screen 84 has an associated view job button 46 which, when activated, causes a job details screen 86 as shown in FIG. 16 to be displayed.

The job details screen 86 is similar to the job details screen 48 shown in FIG. 7 except that boxes useable to enter measurements taken during a maintenance survey are omitted and expected materials details 54 are omitted.

FIGS. 17 to 20 illustrate a second section of the mooring system 10, the second section being useable to search for moorings available for rent or sale, to book moorings available for rent, and to purchase moorings available for sale. In this example, the second section is also useable to search for rental pens and boats for sale.

As shown in FIG. 17, in order for a user to search for and book moorings, a user search screen 100 is served to the appropriate user terminal 12 by the system terminal 22. The user search screen 100 includes search details boxes 102 which facilitate selection of a region to be covered by the search and the type of search, that is a search for moorings or pens for rental or a search for moorings or pens for sale.

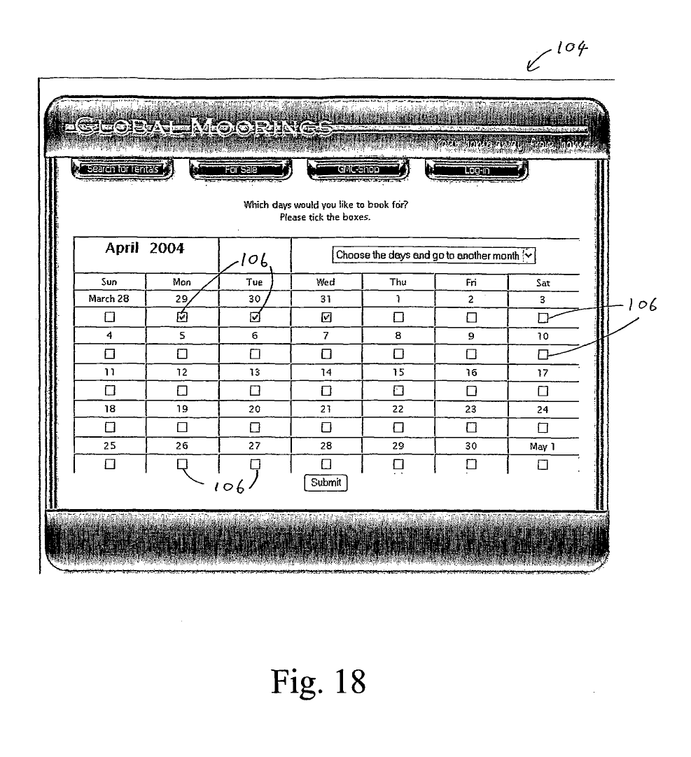

Following selection of the region and search type, a dates selection screen 104 as shown in FIG. 18 is displayed.

The dates selection screen 104 includes dates check boxes 106, each check box 106 corresponding to one day. Using the dates check boxes 106, the user is able to mark the dates on which it is desired to book a mooring or pen.

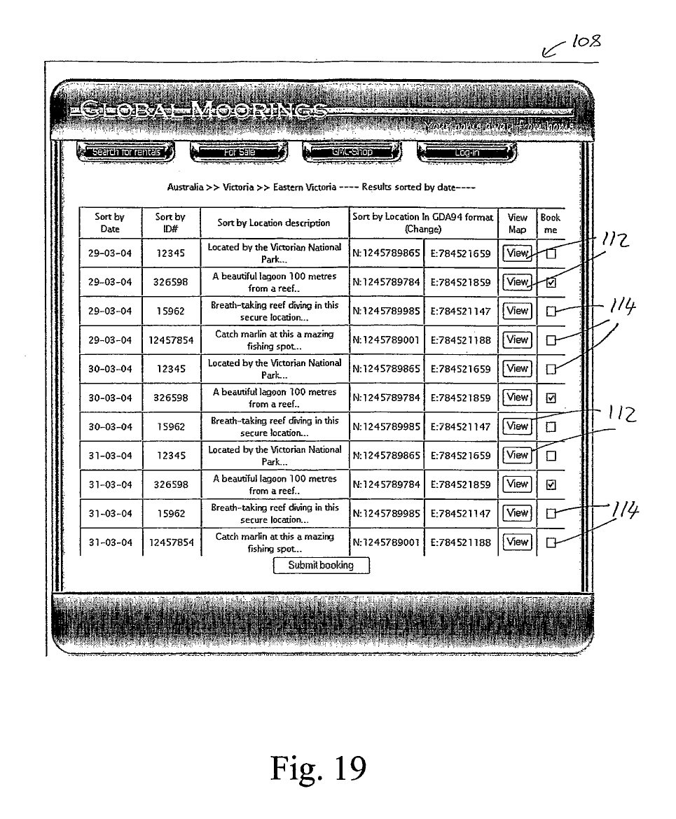

Following selection of the desired dates, an available moorings screen 108 as shown in FIG. 19 is displayed. The available moorings screen 108 lists the moorings or pens which are available for booking on the selected dates together with the location of the mooring or pen. Each mooring displayed on the available moorings screen 108 includes a map button 112 which, when activated, displays a map illustrating the location of the mooring. The available moorings screen 108 also includes a book check box 114 which, when checked, indicates that the user wishes to book the checked mooring or pen. The available moorings screen 108 may also include a link (not shown) to a map which depicts all available moorings.

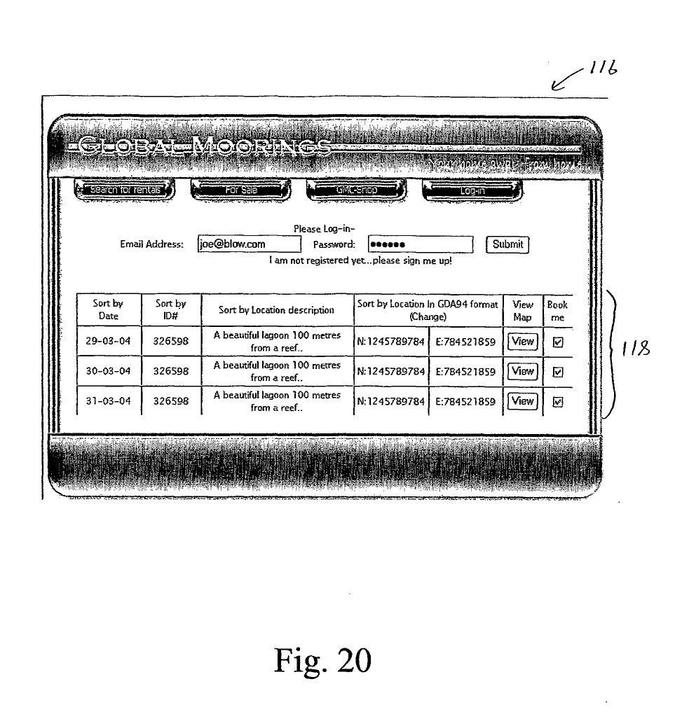

Following selection of the desired moorings or pens, a booked moorings screen 116 as shown in FIG. 20 is displayed. The booked moorings screen 116 includes details of the booked moorings. Details of the booked moorings or pens are then included in the booking information associates with the relevant mooring and pen records stored in the database 24.

Where methods and systems of the present invention may be implemented by software applications, or partly implemented by software, they may take the form of program code stored or available from computer readable media, such as CD-ROMs or any other machine readable media, the program code comprising instructions which, when loaded into a machine such as a computer, the machine then becomes a system for carrying out the invention. The computer readable media may include transmission media, such as cabling fibre-optics or any other form of transmission media.

It will be appreciated that the system may also be used to facilitate searching for and rental of charter vessels such as charter yachts.

It will be appreciated that the system may be implemented at one location, for example at the site of administrators of the mooring system 10, or the system may be implemented by locating different parts of the system at different locations, with the different parts communicating with each other using any suitable communications network, such as the Internet. In the present above described embodiment, the system terminal 22 and the database 24 may be disposed at the same location or may be disposed at different locations and arranged so as to communicate with each other using a suitable communications network.

It will be appreciated that the mooring system of the present invention effectively makes more moorings available for use by the public by allowing users to book privately owned moorings.

It will also be appreciated that by providing a mechanism whereby users are able to book privately owned moorings and pens for use and charging a suitable booking fee, owners of private moorings and pens and controlling authorities may be provided with an income stream. A side effect of this will be to encourage owners of the moorings/pens and controlling authorities responsible for moorings/pens to carry out regular maintenance of the moorings/pens to minimise insurance liability.

It will also be appreciated that by integrating mooring contractors and mooring maintenance with the mooring system, a mechanism is provided for ensuring that moorings are regularly maintained and insurance liability is thereby minimised.

It will also be appreciated that by integrating insurance companies with the mooring system, the insurance companies are able to verify that maintenance is being regularly carried out on moorings and, as a result, insurance premiums payable by controlling authorities and private mooring owners may thereby be minimised.

It will also be appreciated that since the mooring system brings together several mooring contractors, each of which is encouraged to purchase mooring components from one or more suppliers associated with the mooring system, it is possible for each of the mooring contractors to obtain a price for each component which is less than would otherwise be possible.

It will also be appreciated that by providing vessel owners with an increased number of available moorings, boating safety is improved. In addition the vessel owners are encouraged to use moorings instead of the vessel's anchor which assists in maintaining the environment.

It will also be appreciated that the mooring system provides controlling authorities and mooring owners with a non-labour intensive way of monitoring, managing and maintaining moorings.

It will also be appreciated that the mooring system may be arranged to facilitate searching and ordering of marine related equipment, materials, accessories or services.

It will also be appreciated that geographical references to mooring locations displayed by the system may also serve as links to respective maps of the locations of the moorings.

Throughout this specification the term “comprising” is used inclusively, in the sense that there may be other features and/or steps included in the invention not expressly defined or comprehended in the features or steps subsequently defined or described. What such other features and/or steps may include will be apparent from the specification read as a whole.

Modifications and variations as would be apparent to a skilled addressee are deemed to be within the scope of the present invention.

1. A mooring system comprising:
a database arranged to store a plurality of mooring records, each mooring record including:
information indicative of a mooring;
booking information indicative of whether the mooring is booked; and
if the mooring is booked, booking data indicative of the date and/or time period for which the mooring is booked; and
communications means arranged to facilitate communications between the system and a remotely located user device such that booking information is receivable by the remotely located user device from the mooring system for viewing by a user;
wherein the system is arranged so as to facilitate searching by a user through the mooring records based on user defined criteria.

2. A mooring system as claimed in claim 1, wherein the system is arranged such that during use booking data associated with a mooring desired to be booked by a user is receivable from a remotely located user device, and the mooring record associated with the desired mooring is updated so as to indicate that the mooring is booked and so as to include the identity of the user and the date and/or time period for which the mooring is booked.

3. A mooring system as claimed in claim 1, wherein each mooring record includes maintenance information indicative of the condition of a mooring at a previous service.

4. A mooring system as claimed in claim 3, wherein the maintenance information includes information indicative of the expected condition of the mooring at a subsequent service, the suggested next service date, and/or whether each component of the mooring is expected to require replacing at a subsequent service.

5. A mooring system as claimed in claim 3, wherein the maintenance information includes information indicative of measurements of components of a mooring at a previous service.

6. A mooring system as claimed in claim 5, wherein the system is arranged to facilitate entry of measurement data into each mooring record, which data is used to update said measurement information in the mooring record taken at a previous service.

7. A mooring system as claimed in claim 1, wherein the system is arranged so as to facilitate ordering of mooring components and/or marine related equipment, materials, accessories or services.

8. A mooring system as claimed in claim 1, wherein the system is arranged to store information indicative of moorings and/or vessels available for sale and to make information indicative of the moorings and/or vessels available for sale viewable using a remotely located user device.

9. A mooring system as claimed in claim 1, wherein the system is communicable with personal computing devices, portable computing devices, personal digital assistants (PDA) or mobile telephones.

10. A mooring system as claimed in claim 1, wherein the system is arranged to facilitate communications with remote computing devices through the Internet or by SMS messaging.

11. A method of managing moorings, said method comprising the steps of:
providing a database;
storing in the database a plurality of mooring records, each mooring record including information indicative of the mooring and booking information indicative of whether the mooring is booked, and, if the mooring is booked, booking data indicative of the identity of the user in respect of which the mooring is booked and of the date and/or time period for which the mooring is booked;
facilitating communications between the system and a remotely located user device such that booking information is receivable by the remotely located user device from the database for viewing by a user; and
facilitating searching through the mooring records based on user defined criteria.

12. A method as claimed in claim 11, further comprising the steps of:
facilitating reception of booking data from a remotely located user device; and updating a mooring record associated with a mooring so as to indicate the identity of the user and the date and/or time period for which the mooring is booked when booking data associated with the mooring is received from a remotely located user device.

13. A method as claimed in claim 11, further comprising the step of updating the mooring record associated with a desired mooring so as to indicate that the mooring is booked and so as to include the identity of the user and the date and/or time period for which the mooring is booked when booking data associated with the desired mooring is received from a remotely located user device.

14. A method as claimed in claim 11, further comprising the step of storing in the database maintenance information indicative of the condition of a mooring at a previous service.

15. A method as claimed in claim 14, wherein the maintenance information includes information indicative of the expected condition of the mooring at a subsequent service, the suggested next service date, and/or whether each component of the mooring is expected to require replacing at a subsequent service.

16. A mooring system as claimed in claim 14, wherein the maintenance information includes information indicative of measurements of components of a mooring at a previous service.

17. A method as claimed in claim 11, further comprising the step of facilitating ordering of mooring components and/or marine related equipment, materials, accessories or services.

18. A mooring method as claimed in claim 11, further comprising the steps of storing in the database information indicative of moorings and/or vessels available for sale, and making information indicative of the moorings and/or vessels available for sale viewable using a remotely located user device.

19. A method as claimed in claim 11, further comprising the step of facilitating communication between the system and personal computing devices, portable computing devices, personal digital assistants (PDA) or mobile telephones.

20. A method as claimed in claim 11, further comprising the step of facilitating communications with remote computing devices through the Internet or by SMS messaging.

21. A computer program arranged, when loaded into a computer, to instruct the computer to operate in accordance with a mooring system as claimed in claim 1.

22. A computer useable medium having a computer readable program code embodied therein for causing a computer to operate in accordance with a mooring system as claimed in claim 1.
